(19) United States
(12) Patent Application Publication
(10) Pub. No.: US 2018/0156236 A1
(43) Pub. Date: Jun. 7, 2018

(54) GAS TURBINE ENGINE BLEED CONFIGURATION

(71) Applicant: PRATT & WHITNEY CANADA CORP., Longueuil (CA)

(72) Inventor: Hien DUONG, Mississauga (CA)

(21) Appl. No.: 15/367,220

(22) Filed: Dec. 2, 2016

(51) Int. Cl. F04D 29/56; F02C 3/06; F02C 7/042

(52) U.S. Cl. CPC F04D 29/563; F05D 2240/122; F02C 7/042; F02C 3/06

(57) ABSTRACT

A gas turbine engine compressor has an annular gas path, a circumferential array of variable inlet guide vanes (VIGVs), pivotally mounted and positioned within the annular gas path; and a rotor positioned adjacently downstream of the array of variable inlet guide vanes. The rotor has a platform extension extending upstream towards the inlet guide vanes. The platform extension axially overlaps an inner end surface of the variable inlet guide vanes.

### TECHNICAL FIELD

The application relates generally to gas turbine engines and, more particularly, to compressors.

### BACKGROUND OF THE ART

In gas turbine engine compressors, stator vanes are used to provide a downstream rotor with air flow at optimal angles, in terms of such rotor's performance and operability. Because such performance and operability vary depending on air flow conditions, such as speed, such vanes are often required to rotate as a function of such air flow conditions. As the vanes rotate, the gap between the gas path's radially inner wall and the stator vane varies, leading to endwall gap clearance issues such as leakage gap flow. Leakage gap flow mixes with compressor main flow, leading to undesired issues such as mixing losses, flow turning reduction and flow unsteadiness. The reduction of leakage gap flow has been typically addressed by minimising the gap that is at the root of leakage gap flow, but such an approach has its limits. In the context of striving for ever more efficient gas turbine engine compressors, there is a need for addressing leakage gap flow.

### SUMMARY

In one aspect, there is provided a gas turbine engine compressor, comprising: an annular gas path positioned around a centerline, a circumferential array of variable inlet guide vanes, pivotally mounted and positioned within the annular gas path; a rotor, rotatable about the centerline, positioned adjacently downstream of the array of variable inlet guide vanes, the rotor comprising a platform extension extending upstream towards the inlet guide vanes, the platform extension axially overlapping an inner end surface of the variable inlet guide vanes.

In another aspect, there is provided a gas turbine engine compressor, comprising: an annular gas path positioned around a centerline, a circumferential array of stator vanes, pivotally mounted and positioned within the annular gas path, each stator vane comprising an inner end surface and an outer end surface, and a circumferential surface positioned either radially inward of the inner end surface or radially outward of the outer end surface; wherein, when the compressor is in operation, the circumferential surface rotates about the centerline in a generally counter-direction to an anticipated direction of a leakage gap flow occurring circumferentially over the inner or outer end surface.

In a further aspect, there is provided a method of mitigating, in a compressor of a gas turbine engine with an annular gas path wall, leakage gap flow occurring circumferentially over a trailing edge end surface of a circumferential array of stator vanes, the method comprising: introducing a rotating circumferential surface in a portion of the annular gas path wall section which overlaps with the trailing edge end surface of the stator vanes, in operation, the circumferential surface rotating in a counter-direction to an anticipated direction of the leakage gap flow occurring circumferentially over the trailing edge end surface.

Further details of these and other aspects of the subject matter of this application will be apparent from the detailed description and drawings included below.

### DESCRIPTION OF THE DRAWINGS

Reference is now made to the accompanying figures in which:

FIG. 1 is a schematic cross-sectional view of a gas turbine engine;

FIG. 2A is a cross-sectional view of a prior art compressor section of a gas turbine engine;

FIG. 2B is a cross-sectional view of a compressor section of a gas turbine engine pursuant to an embodiment of the invention;

FIG. 3A is a rear elevation detailed view of an endwall gap of a prior art compressor section of a gas turbine engine;

FIG. 3B is a rear elevation detailed view of an endwall gap of a compressor section of a gas turbine engine pursuant to an embodiment of the invention;

FIG. 4 is an isometric view of an inlet guide vane pursuant to an embodiment of the invention;

FIG. 5 is a plan view of inlet guide vanes and rotor blades of a compressor section of a gas turbine engine; and

FIG. 6 is a plan view of stator vanes and rotor blades of a compressor section of a gas turbine engine.

### DETAILED DESCRIPTION

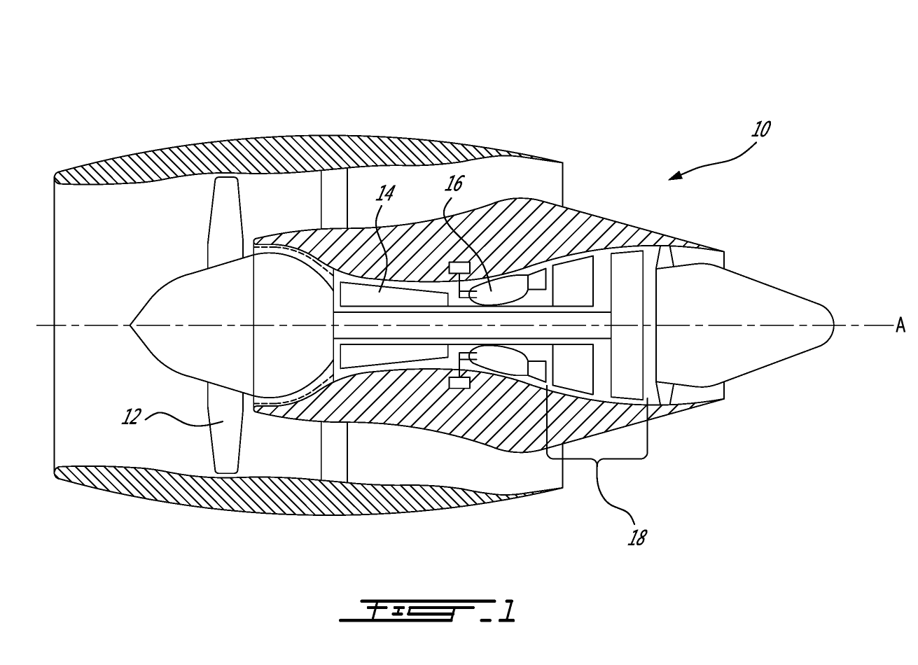

FIG. 1 illustrates a gas turbine engine 10 of a type preferably provided for use in subsonic flight, generally comprising in serial flow communication a fan 12 through which ambient air is propelled, a compressor section 14 for pressurizing the air, a combustor 16 in which the compressed air is mixed with fuel and ignited for generating an annular stream of hot combustion gases, and a turbine section 18 for extracting energy from the combustion gases. Gas turbine engine 10 and its various parts outlined above are concentrically mounted about centerline A as is well known in the art.

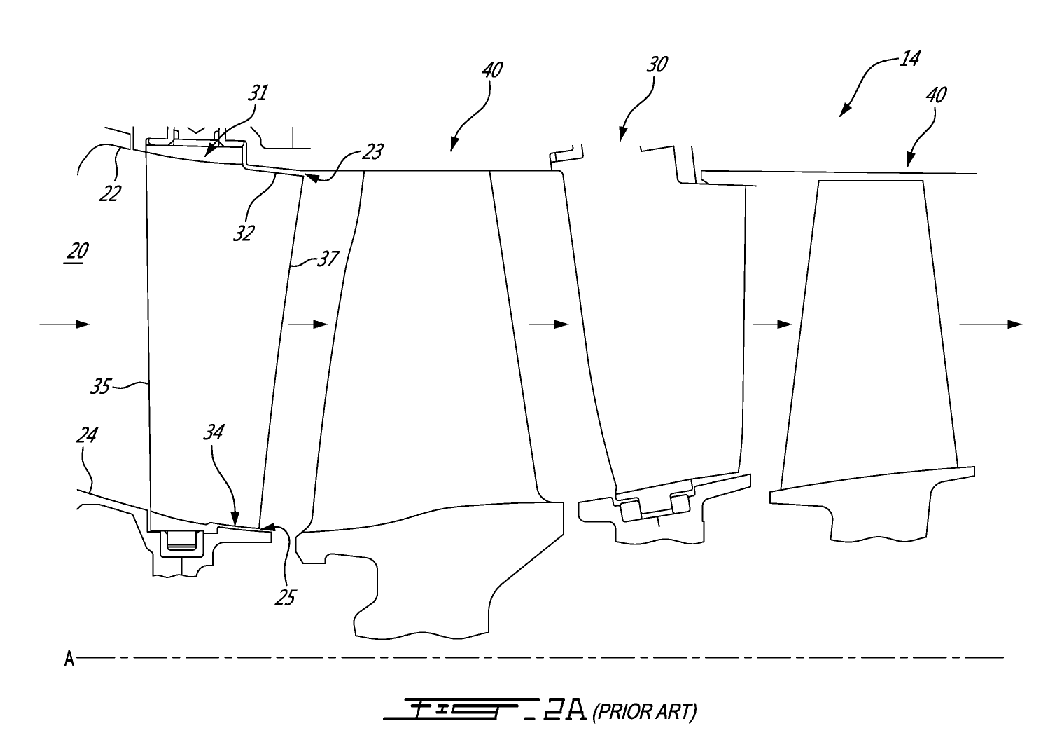

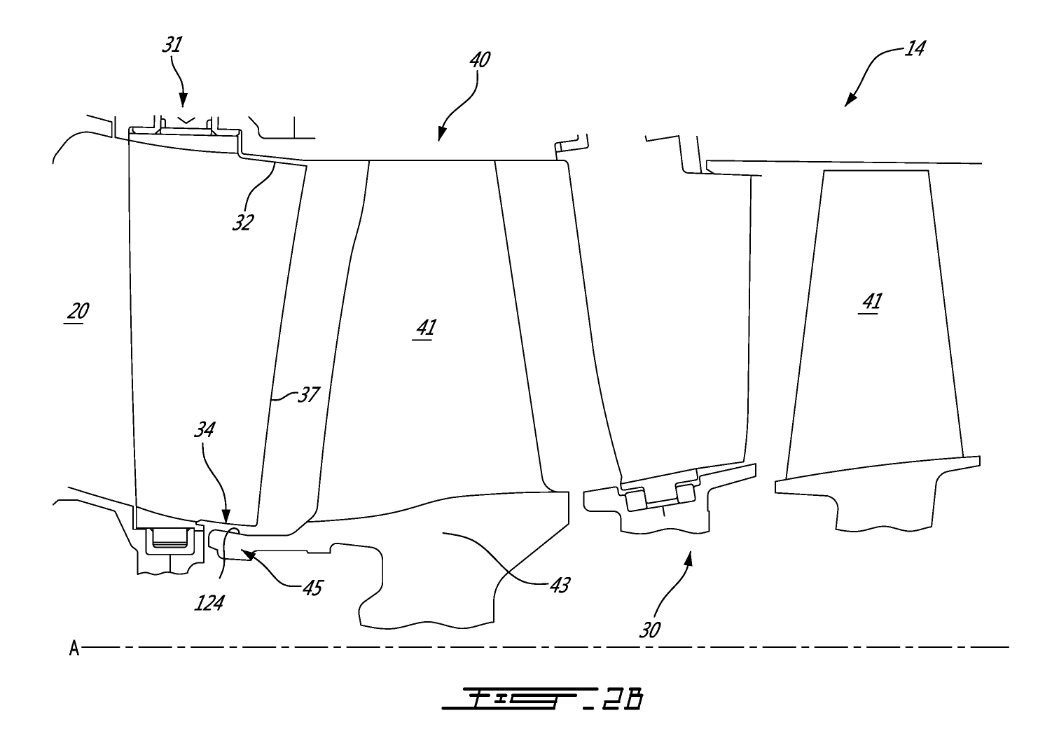

As is well-known in the art and shown in FIG. 2A, compressor section 14 is a succession of stators and rotors, positioned in an annular gas path 20, for compressing the air (shown schematically by arrows) flowing through it. More specifically, annular gas path 20 is circumscribed by a circumferential radially outer wall 22 and a circumferential radially inner wall 24. The first portion of compressor section 14 that is encountered by the upstream air is typically a stator vane known as an inlet guide vane (IGV) 31. The air then flow through a succession of rotors 40 and stator vanes 30. IGV 31, as with all compressor stator vanes 30, is designed to provide an adjacently downstream positioned rotor 40 with air at an optimal angle, in terms of such rotor 40's performance and operability. As the optimal air angle varies depending on air flow conditions, such as speed, the IGV 31 and the downstream stator vanes 30 are allowed to rotate about respective span axis within gas path 20. Such vanes are known as “variable” guide vanes. Accordingly, the IGVs 31 are variable inlet guide vanes (VIGV). The inlet guide vanes 31 are sometimes herein referred to as IGV for brevity.

As shown in FIG. 2A, the IGVs 31 are pivotally secured to gas path walls 22, 24, around a span axis close to leading edge 35 of IGV 31. Inner end surface 34 extends therefrom towards trailing edge 37 of IGV 31, i.e. extends downstream. Similarly, outer end surface 32 extends therefrom towards trailing edge 37 of IGV 31, i.e. extends downstream.

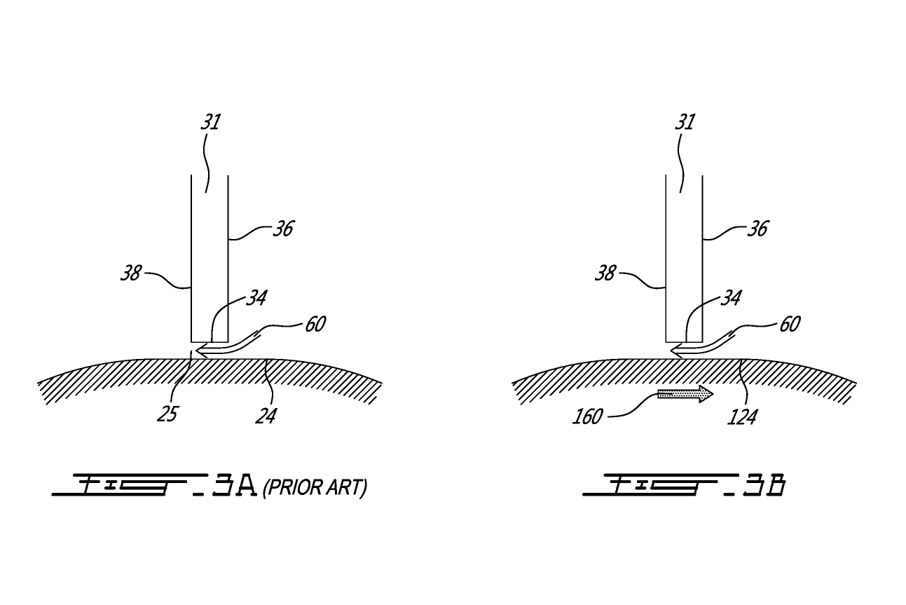

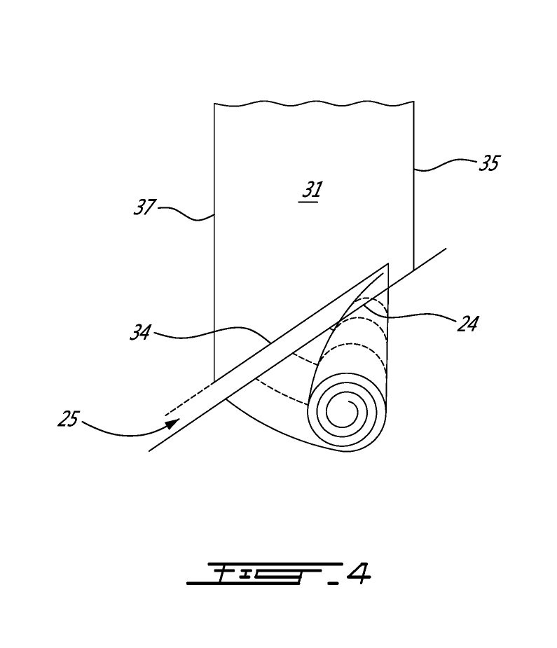

To avoid contact between rotatable IGVs 31 and walls 22, 24, endwall gaps 23, 25 are introduced. More specifically, as shown in FIGS. 2A, 3A and 4, radially inner endwall gap 25 is introduced between radially inner wall 24 and inner end surface 34 and radially outer endwall gap 23 is introduced between radially outer wall 22 and outer end surface 32 (FIGS. 3A & 4 only shows radially inner endwall gap 25 between radially inner wall 24 and inner end surface 34). Such endwall gaps 23, 25 vary as the VIGVs 31 rotate.

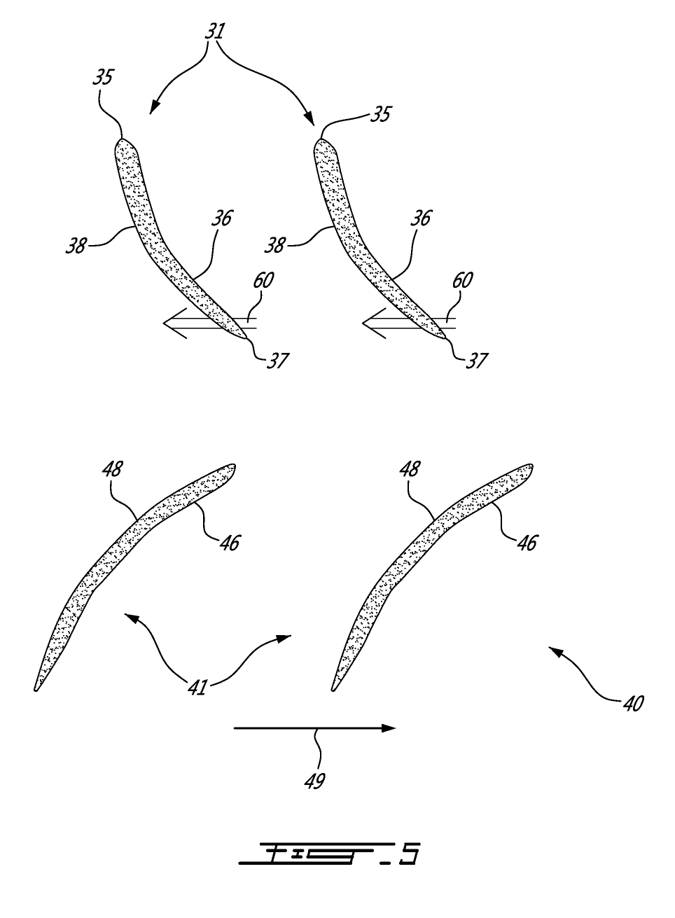

Because of pressure differential across stator vanes 30, 31 leakage gap flow occurs. More specifically, as shown in FIGS. 3A, 4 & 5 with respect to radially inner endwall gap 25 of variable inlet guide vane 31, air flows from a pressure side 36 of inlet guide vane 31 to a suction side 38 of inlet guide vane 31: such air flow is known as leakage gap flow 60 (shown schematically as a double-lined arrow in FIGS. 3A & 5 flowing over inner end surface 34) and, as outlined above, vary in intensity as the variable vanes rotate.

As shown schematically in FIG. 3B, it is herein suggested to locally replace wall 24 with a rotating circumferential surface 124 which, when engine 10 is in operation, rotates in a direction (shown schematically as item 160) opposite to leakage gap flow 60. As circumferential surface 124's boundary layer is dragged in a direction opposite leakage gap flow 60's direction, this has a moderating effect on leakage gap flow 60's intensity. Indeed, the flow generated by rotating circumferential surface 124, because its direction is opposite leakage gap flow 60's direction, reduces the effective area for such leakage gap flow, thereby reducing such leakage gap flow.

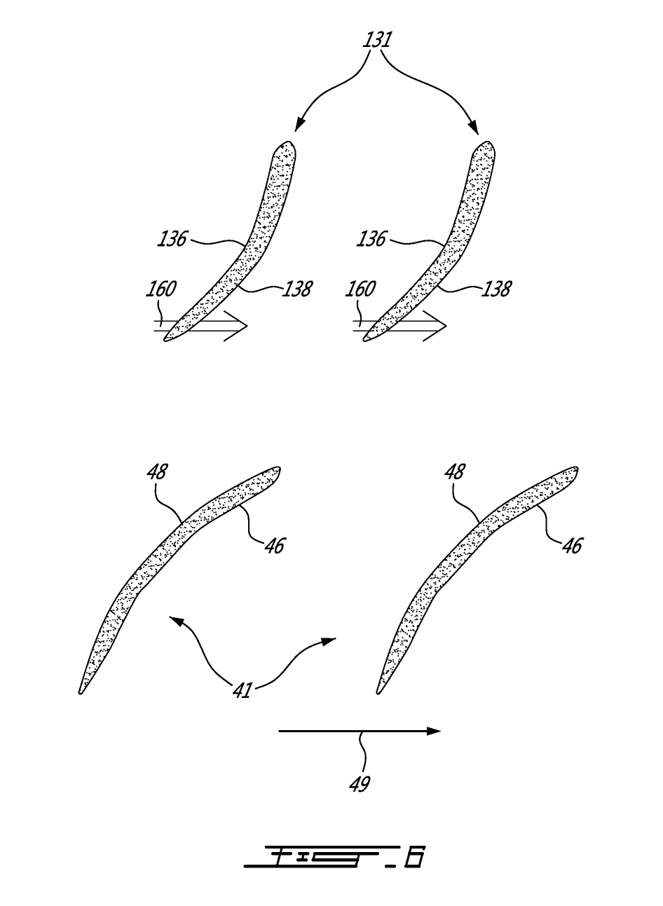

As shown in FIG. 5, rotor 40 positioned immediately downstream of inlet guide vane 31 is rotating in a direction (shown schematically as item 49) opposite direction of leakage gap flow 60. Consequently, as shown in the embodiment in FIG. 2B, rotating circumferential surface 124 can be formed by an axial extension of rotor 40. More specifically, rotor 40 comprises an array of rotor blades 41, rotatable around centerline A and radially extending into gas path 20 from a platform 43. Platform 43 has an axial extension 45, extending upstream towards inlet guide vanes 31, more specifically towards trailing edge 37 of inlet guide vanes 31, so as to axially overlap with inner end surface 34. Platform axial extension 45 therefore acts locally as the radially inner wall 24 of gas path 20, more specifically as a rotating boundary. When compared with prior art compressors, rotating circumferential surface 124 is taking the place of a static gas path boundary.

In operation, it is understood that flow through variable inlet guide vanes 31 (i.e. the first stage of compressor vanes) is normally accelerated from leading edge 35 to trailing edge 37. As shown in FIG. 5, both suction side 38, 48 and the pressure sides 36, 46 for the inlet guide vanes 31 and the downstream rotor blades 41 are on the same side because of velocity vectors are for flow acceleration in the inlet guide vanes. As such, when rotating, the blades 41 drags the flow under the variable inlet guide vanes 31 from suction side 38 to pressure side 36. That is against the direction of leakage flow 60, thereby mitigating leakage flow.

The above description is meant to be exemplary only, and one skilled in the art will recognize that changes may be made to the embodiments described without departing from the scope of the present disclosure. For example, as shown in FIG. 5, because leakage gap flow 60 of variable inlet guide vanes 31 flow in a direction opposite rotating direction of rotor 40 positioned immediately downstream of inlet guide vanes 31, rotating circumferential surface 124 can be formed by an upstream axial extension to such rotor 40. It should be noted that inlet guide vanes 31's suction side 38 and pressure side 36 are circumferentially arranged in a similar sequence to rotor blades 41's suction side 48 and pressure side 46; stated differently, as one travels clockwise across the array of inlet guide vanes 31 (i.e. from left to right on FIG. 5), one first encounters each inlet guide vane 31's suction side 38, and as one travels clockwise across the array of rotor blades 41, one first encounters each rotor blade 41's suction side 48. However, as is shown in FIG. 6, in other segments of compressor section 14 where stator vanes 131's suction side 138 and pressure side 136 are circumferentially arranged in a different sequence to rotor blades 41's suction side 48 and pressure side 46 (i.e. as one travels clockwise across the array of stator vanes 131, one first encounters each stator vane 131's pressure side 136, whereas as one travels clockwise across the array of rotor blades 41, one first encounters each rotor blade 41's suction side 48), leakage gap flow 60 of stator vanes 131 flow in a direction that is the same as rotating direction of rotor 40 positioned immediately downstream of stator vanes 131. Therefore, in the instance shown in FIG. 6, having rotating circumferential surface 124 formed by an upstream axial extension to such rotor 40, would increase leakage gap flow 60's intensity. In such instance, rotating circumferential surface 124 would have to be formed otherwise so that it rotates in a generally counter-direction to an anticipated direction of leakage gap flow 60's direction (i.e. circumferential surface 124 would have to rotate from right to left in FIG. 6). For instance, if we have a cantilever stator (normally last stator in the low pressure or load compressor) and the downstream rotor is on a different shaft and rotating in the opposite direction, then the same principles apply.

Still other modifications which fall within the scope of the present invention will be apparent to those skilled in the art, in light of a review of this disclosure, and such modifications are intended to fall within the appended claims.

1. A gas turbine engine compressor, comprising:
an annular gas path positioned around a centerline,
a circumferential array of variable inlet guide vanes, pivotally mounted and positioned within the annular gas path;
a rotor, rotatable about the centerline, positioned adjacently downstream of the array of variable inlet guide vanes, the rotor comprising a platform extension extending upstream towards the inlet guide vanes, the platform extension axially overlapping an inner end surface of the variable inlet guide vanes.

2. The gas turbine engine compressor as defined in claim 1, wherein the platform extension locally defines a radially inner wall of the gas path, the radially inner wall facing the inner end surface of the variable inlet guide vanes.

3. The gas turbine engine compressor as defined in claim 1, wherein the rotor comprises an array of rotor blades radially extending into the gas path from a platform, and wherein the platform extension is an axial extension from the platform.

4. The gas turbine engine compressor as defined in claim 3, wherein the platform axial extension defines the annular gas flow path's radially inner facing the inner end surface.

5. The gas turbine engine compressor as defined in claim 1, wherein each variable inlet guide vanes has a pressure side, wherein the rotor comprises a circumferential array of blades, each blade having a pressure side, and wherein the pressure sides of both the blades and the variable inlet guide vanes face a same direction.

6. The gas turbine engine compressor as defined in claim 1, wherein the variable inlet guide vanes have opposed pressure and suction sides, wherein the rotor has a circumferential array of blades having opposed pressure and suction sides, and wherein the suction and pressure sides of the variable inlet guide vanes are circumferentially arranged in a similar sequence to the suction and pressure sides of the blades.

7. A gas turbine engine compressor, comprising:
an annular gas path positioned around a centerline,
a circumferential array of stator vanes, pivotally mounted and positioned within the annular gas path, each stator vane comprising an inner end surface and an outer end surface, and
a circumferential surface positioned either radially inward of the inner end surface or radially outward of the outer end surface;
wherein, when the compressor is in operation, the circumferential surface rotates about the centerline in a generally counter-direction to an anticipated direction of a leakage gap flow occurring circumferentially over the inner or outer end surface.

8. The gas turbine engine compressor as defined in claim 7, wherein the stator vanes are inlet guide vanes.

9. The gas turbine engine compressor as defined in claim 8, wherein the circumferential surface is positioned radially inward of the inner end surface of the inlet guide vanes.

10. The gas turbine engine compressor as defined in claim 9, wherein the circumferential surface defines a radially inner wall of the gas path, the circumferential surface facing the inner end surface of the inlet guide vanes.

11. The gas turbine engine compressor as defined in claim 8, wherein the circumferential surface is defined by an axial blade platform extension to a rotor positioned adjacently downstream of the array of inlet guide vanes.

12. The gas turbine engine compressor as defined in claim 11, wherein the circumferential surface defines the inner wall of the gas path and faces the inner end surface of the inlet guide vanes.

13. The gas turbine engine compressor as defined in claim 7, comprising an array of rotor blades positioned adjacently downstream of the array of stator vanes, the rotor blades having suction and pressure sides, and wherein the stator vanes have suction and pressure sides similarly circumferentially arranged to the suction and pressure sides of the rotor blades.

14. The gas turbine engine compressor as defined in claim 13, wherein the circumferential surface is positioned radially inward of the inner end surface of the stator vanes.

15. The gas turbine engine compressor as defined in claim 14, wherein the circumferential surface defines a radially inner wall of the gas path, the circumferential surface facing the inner end surface of the stator vanes.

16. The gas turbine engine compressor as defined in claim 13, wherein the circumferential surface is defined by an axial blade platform extension to the array of rotor blades.

17. The gas turbine engine compressor as defined in claim 16, wherein the circumferential surface defines a radially inner wall of the gas path and faces the inner end surface of the stator vanes.

18. A method of mitigating, in a compressor of a gas turbine engine with an annular gas path wall, leakage gap flow occurring circumferentially over a trailing edge end surface of a circumferential array of stator vanes, the method comprising:
introducing a rotating circumferential surface in a portion of the annular gas path wall section which overlaps with the trailing edge end surface of the stator vanes, in operation, the circumferential surface rotating in a counter-direction to an anticipated direction of the leakage gap flow occurring circumferentially over the trailing edge end surface.

19. The method as defined in claim 18, wherein, in a compressor comprising an array of rotor blades positioned adjacently downstream of the array of stator vanes, the circumferential surface is defined by an axial extension of a platform of the array of rotor blades.

20. The method as defined in claim 18, wherein, in a compressor where the array of stator vanes is an array of inlet guide vanes, the circumferential surface is defined by an axial extension of an array of rotor blades positioned adjacently downstream of the inlet guide vanes.
